(19) United States
(12) Patent Application Publication
(10) Pub. No.: US 2011/0108035 A1
(43) Pub. Date: May 12, 2011

(54) Nex-Gen Respirator / Surgical Mask

(76) Inventor: Richard Samaniego, Lakeside, TX (US)

(21) Appl. No.: 12/945,795

(22) Filed: Nov. 12, 2010

Related U.S. Application Data
(60) Provisional application No. 61/280,992, filed on Nov. 12, 2009.

(51) Int. Cl. A62B 23/02; B23P 17/04; B29C 45/00; B29C 51/00

(52) U.S. Cl. 128/206.17; 29/428; 264/319

(57) ABSTRACT

A face mask for use as a procedure mask, isolation mask or dental face mask having a transparent shell with one opening for covering the nose and mouth of a person and a housing having a first and a second air passageway with a chamber located therebetween for holding a replaceable filter coupled to the one opening in the transparent shell. Elastic straps which are attached to the transparent shell are adapted to be placed around a user's head to hold the transparent shell against the face of the user and the transparent shell is made of a clear latex free plastic.

### REFERENCE TO RELATED APPLICATIONS

This patent application claims the benefit of U.S. Provisional Application No. 61/280,992 filed on Nov. 12, 2009, the disclosure of which is incorporated herein by reference in its entirety.

### BACKGROUND OF THE INVENTION

1. Field of the Invention

The present invention relates generally to face masks capable of preventing the passage of airborne aerosols, particulate matter and/or liquids and, more specifically, to latex free face masks made of soft durometer clear plastic material which is both air and water non-permeable for use as a procedure mask, isolation mask or dental face mask.

2. Description of Related Art

A surgical mask which is also known as a procedure mask is intended to be worn by health professionals during surgery and at other times to catch the bacteria shed in liquid droplets and aerosols from the wearer's mouth and nose.

Modern surgical masks are made from paper or other non-woven material, and should be discarded after each use. Simple surgical masks protect wearers from being splashed in the mouth with body fluids. They also remind wearers not to touch their mouth or nose, which could otherwise transfer viruses and bacteria after having touched a contaminated surface. They can also reduce the spread of infectious droplets which carry bacteria and viruses. However, they are not designed to protect the wearer from inhaling such particles. They will trap some particles but are much less effective than respirators, which are designed for this purpose.

Safety guidelines for healthcare workers recommend the wearing of a face-fit tested respirator mask which conforms to United States standard NIOSH N-95 or European standard EN 149 FFP3 when in the vicinity of pandemic flu patients, to reduce the exposure of the wearer to potentially infectious aerosols and airborne liquid droplets.

In its guidance regarding the 2009 swine flu outbreak, the U.S. Centers for Disease Control and Prevention said “ . . . Information on the effectiveness of facemasks and respirators for the control of influenza in community settings is extremely limited. Thus, it is difficult to assess their potential effectiveness in controlling swine influenza A (H1N1) virus transmission in these settings . . . ” If used correctly, facemasks and respirators may help reduce the risk of getting influenza, but they should be used along with other preventive measures, such as avoiding close contact and maintaining good hand hygiene.

Wearing protective face masks has become standard procedure for many health care and other related activities. The use of a face mask is important, for example, to lab technicians while conducting tests, to nurses during the care of patients, to physicians during surgery and other types of medical treatment, and to dentists working in a patient's mouth.

During the past several years, health care personnel have become more aware of the potential hazards associated with airborne pathogens, such as the hepatitis B virus and infectious tuberculosis associated with many HIV patients. It has been found that aerosols having airborne liquid and solid particles are generated not only by the exhalation of infected patients, but also by certain procedural manipulations and processes that impart energy to microbial suspensions. A considerable number of studies have been made which are now beginning to identify the transmission of viruses through “non-accident” situations.

Face masks for covering a person's nose and mouth is known in the prior art. More specifically, by way of example, U.S. Pat. No. 6,055,982 to Brunson, et al. discloses a disposable face mask that includes a filter body formed from multiple layers of filtration material having various configurations.

U.S. Pat. No. 5,596,985 to Collier discloses a surgical mask which protects a wearer's face, neck and upper chest region from exposure to bodily fluids expelled by a patient which is resistant to fluids yet permeable by ambient gases for covering the wearer's nose and mouth.

U.S. Pat. No. 5,584,078 to Saboory discloses a shield that is attached to an unmodified, standard surgical mask. The shield is a fluid-impervious, transparent panel for protecting the eyes and face of the wearer.

U.S. Pat. No. 5,553,608 to Reese, et al. discloses a face mask which has a filter body which is formed from multiple layers of filtration material having a generally rectangular configuration with a plurality of pleats which may be formed from resilient or stretchable material.

U.S. Pat. No. 5,419,318 to Tayebi discloses a mask that provides a cup in which the chin of the mask wearer rests to prevent the mask from slipping under the chin of the wearer, and a peripheral rim over the nose of the wearer that secures the bottom edge of protective eyewear between the rim and the face of the mask wearer. The outer shell member is either an air permeable material for filtering particulates and/or gases from breathed air, or may be a rigid air impervious material through which filter cartridges are mounted to filter breathed air.

U.S. Pat. No. 5,012,805 to Muckerheide discloses a surgical mask which has a non-porous shield worn in conjunction with a conventional surgical mask. The apparatus includes ridges which cooperate with the structural ridges of a conventional surgical respiratory mask so that air passages are formed therebetween to provide normal breathing for the wearer.

U.S. Pat. No. 4,616,647 to McCreadie discloses a face mask of molded fibrous sheet material which has a cup-shaped main body with two spaced, generally parallel, integral, interior nose portions filter-seals which are located to engage opposed sides of the nose of the wearer.

U.S. Pat. No. 4,469,097 to Kelman discloses a mask with s breathing apparatus which provides short bursts of oxygen separated by longer intervals of time to the wearer to supplement his/her breathing.

U.S. Pat. No. 4,419,993 to Petersen discloses a mask having a filter which is divided into an upper region and a lower region where the lower region of the filter is more permeable to air than the upper region of the filter.

U.S. Pat. No. 4,037,593 to Tate, Jr. discloses a mask with a vapor barrier for preventing clouding or fogging of glasses used by the wearer of the mask.

### SUMMARY OF THE INVENTION

In an exemplary embodiment of the present invention, there is disclosed a face mask for use as a procedure mask, isolation mask or dental face mask having a transparent shell with one opening for covering the nose and mouth of a person and a housing having a first and a second air passageway with a chamber located therebetween for holding a replaceable filter coupled to the one opening in the transparent shell. Elastic straps which are attached to the transparent shell are adapted to be placed around a user's head to hold the transparent shell against the face of the user and the transparent shell is made of a clear latex free plastic.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of the mask having a clear plastic shell is accordance with the principles of the invention;

FIG. 2 is a side view of the mask of FIG. 1 on the face of a user;

FIG. 3 is a side view of a clear or opaque plastic housing which is attached to the mask of FIGS. 1 and 2 for receiving a filter that is used to block the passage of bacteria and viruses in accordance with the principles of the invention;

FIG. 4 is a side view of a clamp for holding the plastic housing to the mask; and

FIG. 5 is a side view of a “T” type of connector for reorienting the position of the filter from a vertical position to a horizontal position.

### DESCRIPTION OF THE PREFERRED EMBODIMENT

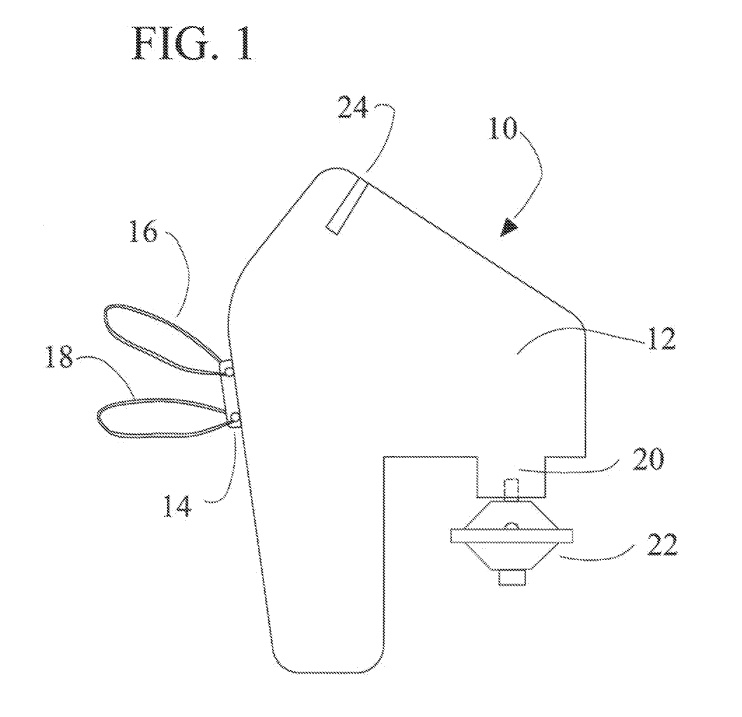

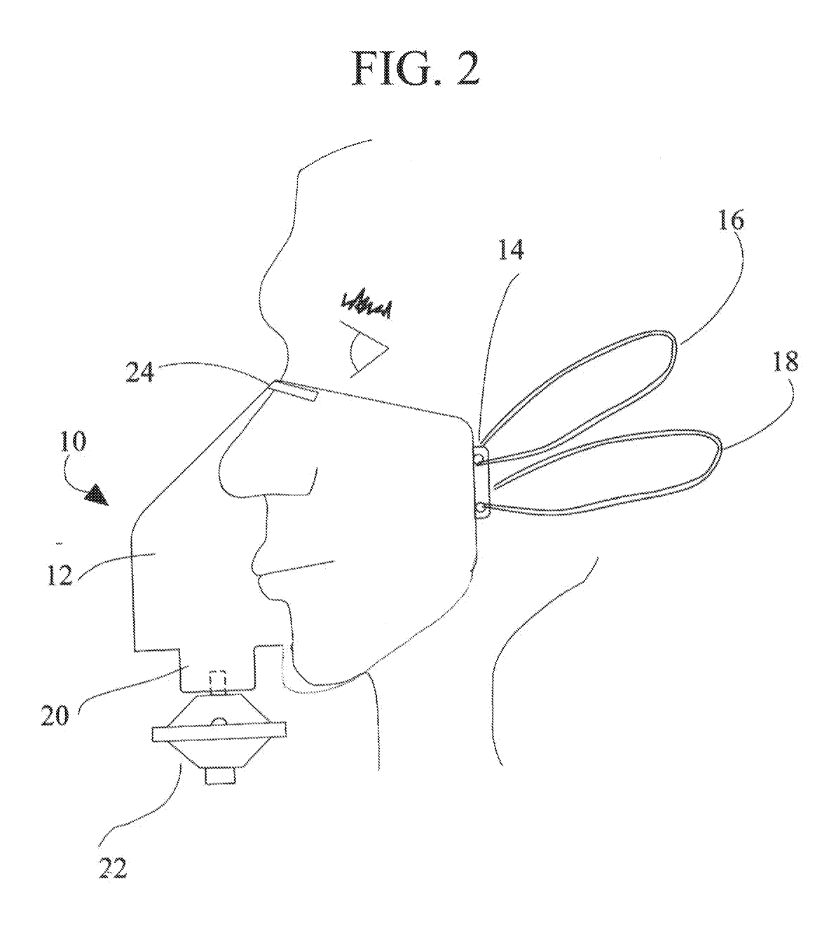

Referring to FIGS. 1 and 2, there is disclosed a side view of a mask made of clear transparent material attached to a housing for a filter which may be clear or opaque in accordance with the principles of the invention. The clear mask 10 is made of one continuous shell 12 which fits around the front of the user's face and below his/her chin. Small tabs 14 located at each side of the mask have openings for receiving elastic bands 16, 18 which are located around the head of a user to hold the mask against the face of a user. The holding force provided by the elastic bands is sufficient to hold the mask against the face of a user to insure that there is an effective seal between the periphery of the shield of the mask and the face of the user.

The mask is composed of a shield of Latex free material made of a soft durometer plastic. A soft durometer plastic which is used to make the mask may, for example, be a clear polymer gel or a clear polyethylene plastic that is free of Latex which has a Shore A durometer greater than 5 and less then 20. As disclosed herein any clear transparent material which has a Shore A durometer greater than 5 and less than 20 is classified as a soft durometer material.

The American Society for Testing and Materials (ASTM) provides at least two common durometer scales, the “A” scale for softer materials and the “D” scale for harder ones. Each scale has values of between zero for soft materials, and 100 for hard materials. For example, rubber which is used to make an elastic band can have a durometer value of 25 on the A scale and the rubber in an automobile tire can have a durometer value of 50 on the D scale. The durometer value of the material used for masks and shells of masks herein are measured on the “A” scale.

The shell 12 of the mask is composed of an air impervious material such as a soft, latex free material of clear polymer gel or a clear polyethylene plastic which has a Shore A durometer value which is greater than 5 and less then 20. The shell covers the user's nose and mouth and has only one opening 20 which is adapted to receive a filter cartridge 22 which has a clear transparent or opaque housing. The shell 12 may be formed by injection molding, by thermoforming or by any other forming process.

Opening 20 in the air and liquid impervious shell is adapted to receive a filter cartridge which filters out bacteria and viruses and is encased within a chamber formed by the clear or opaque plastic housing which quarantines the bacteria and viruses within the chamber. A flexible aluminum nose piece 24 is provided to help ensure a tight fit between the shell and a user's face.

In one embodiment the mask has a width of about three inches, an overall height of about five and three-eighths inches and a depth of about three inches. Referring to FIG. 3, there is shown a side view of a plastic housing having a chamber for receiving a filter that is used to block the passage of bacteria and viruses. The housing 22 has a first tube 26 with an air passageway 28 having a diameter of about twenty two millimeters which is adapted to be received by the opening 20 in the air and liquid impervious shell 12. Tube 26 is connected to a chamber 28 which in turn is connected to a tube 30 having a diameter of about fifteen millimeters. Chamber 28 can have two halves which can be threaded or snap fitted together at their center 32 to form an air tight seal. Chamber 28 is sized to receive a filter cartridge 34 that blocks the passage of bacteria and viruses and is a type of filter cartridge that is well known in the art such as an Electrostatic Nanofiber Technology filter. When the two halves of the clear plastic housing are threaded together, they form a chamber having an air tight seam.

Electrostatic Nanofiber Technology filter have the following benefits and characteristics.
Increased filter life.
No fiber shedding.
Improved dust holding capacity.
Lower pressure drop.
Lower airflow resistance.
Improved breathability.
Ideal for heavy excursion applications.
Biocompatible.
Restorable.
Hydrophobic.
Flame resistant.
Biodegradable.
Particles remain held in place even when wet.
Impressive strength properties when wet.
Resistant to high temperatures.

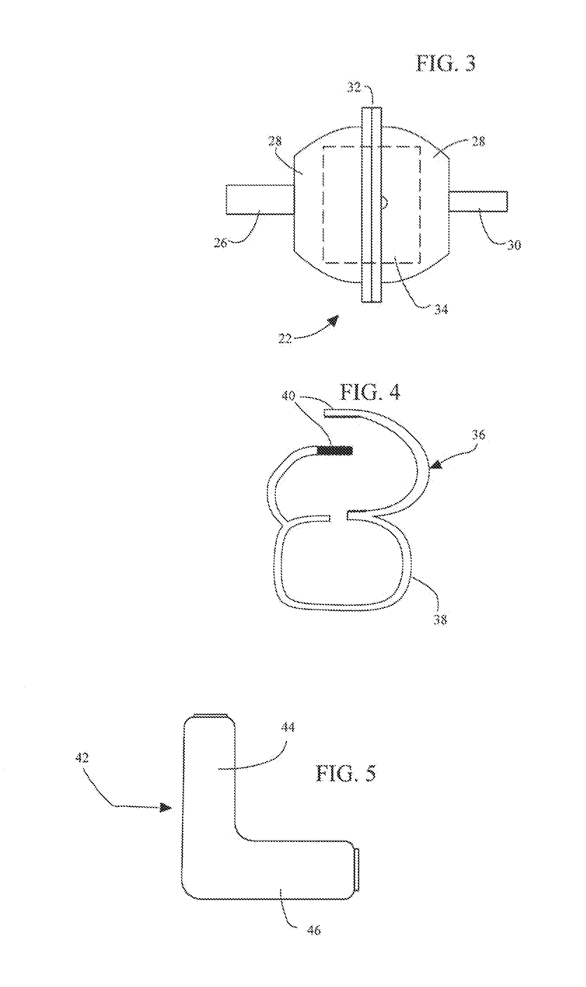

Referring to FIG. 4, there is shown a side view of a clamp for holding the plastic housing to the mask. The clamp 36 can have a split ring 38 which is adapted to be placed around and clamped tight around the tube 20 to lock the tube 26 of the filter housing 22 to the mask with releasable locking means 40.

In the embodiment disclosed, the plastic housing for the bacteria and virus blocking filter is positioned vertically when the mask is in use. In another embodiment the plastic housing and the bacteria and virus blocking filter is positioned horizontally when the mask is in use.

Referring to FIG. 5, there is disclosed a side view of an elbow type of connector which is used to position the plastic housing and bacteria and virus blocking filter located in the housing horizontally when the mask is in use. In an embodiment the elbow 42 has a fifteen millimeter diameter tube 44 connected to a twenty two millimeter diameter tube 46. When in use, the tube 46 of the elbow 42 is inserted into the tube 20 of the mask and clamped in place. The tube 30 of the filter housing 22 is inserted into the tube 44 of the elbow and is also clamped in place with a clamp similar to clamp 36 but of a smaller size.

Fabric and material N-95/Surgical masks worn longer than 20 minutes in an aerosol environment lose their protective quality and allow microorganisms to penetrate through wet material by a process called “wicking”. Thus, a fabric and material N-95/Surgical mask should be changed every 20 minutes during procedures that generate heavy fluid exposure or contact with wearer's nostrils or lips. The mask disclosed can be used when exposed to heavy fluids for extended periods of time without being changed.

The comparison chart below lists some of the advantages of the new improved mask here disclosed when compared with the fabric and material N-95 and/or the Surgical mask.

COMPARISON CHART

| | RESPIRATOR | TRADITIONAL |
|---|---|---|
| FEATURE | HERE DISCLOSED | RESPIRATOR |
| TRANSPARENT FACE MASK | YES | NO |
| (VISUAL INTERACTION) | | |
| WATERPROOF FILTER | YES | NO |
| | (PROTECTED) | (INEFFECTIVE IF WET) |
| SWEAT PROOF FILTER | YES | NO |
| | (PROTECTED) | (INEFFECTIVE IF WET) |
| REPROCESSING | YES | NO |
| RE-USEABLE FILTER | YES | NO |
| | (PROTECTED) | |
| REPLACEABLE FILTER | YES | NO |
| | (ECONOMICAL) | (DISPOSABLE) |
| FILTER | OVER 99.99+% VIRAL | N-95 MATERIAL |
| | & BACTERIAL | INEFFECTIVE IF WET |
| | HYDROPHOBIC FILTER | |
| COST | ECONOMICAL | ECONOMICAL |
| | ($ 4.50 EACH) | |
| STORAGE BAG | YES | NO |
| FILTER LIFE | 240 HOURS | AFTER EACH USE |
| | (THIRTY 8 HR. DAYS) | OR WET, DAMP |
| | | -INEFFECTIVE- |

### Some Additional Advantages of the Mask Here Disclosed are as Follows

Transparent mask allows facial interaction
(No transparent surgical mask is available)
240 hours of filter usable life
(Surgical Mask—Filtering Life is 20 Minutes)
Has the capability of producing an airtight seal between face and mask
(All surgical masks or any fabric mask cannot produce an airtight seal because the mask is air permeable)
Reusable for same user
(Surgical Masks are Disposable and not Recommended for Reuse)
Filter is not accessible—No contamination possible
(Surgical Mask Filter can Easily be Touched Causing Contamination)
Filter can be replace with a new filter using the same mask
(Surgical Masks do not have this Capability)
Blood and body fluids cannot penetrate the non-latex plastic mask
(Blood and body fluids can be absorbed and penetration can occur at a certain pressure velocity on all surgical or fabric masks)
Mask disclosed is effective during raining conditions, filter is protected by a clear plastic housing
(Surgical mask or any fabric respirator mask becomes ineffective if it becomes wet)

Various safety and Healthcare associations have the following concerns about the N95 Respirator Mask performance. The mask becomes ineffective with sweat and exhaling breath (condensation). Within 20 minutes of use the filter pore size will change due to moisture. The filter will become contaminated by touch (95% efficiency). It is not reusable after each use. Heat builds up during use and it is difficult to breathe through for long periods.

The respirator mask here disclosed has resolved these concerns and has the following advantages:
It is easily and quickly seal tested for air tightness.
It has a hydrophobic filter (240 hours or thirty 8 hour shifts)
The filter is sonically sealed (99.99+0/0 efficiency against bacteria & viruses)
The mask is reusable (reprocessing capability).
The user stays cool and can easily breathe through the mask for long periods.
The mask material is non-latex
The filter is FDA cleared
The mask is transparent which allows visual facial interaction.
The mask is economical to use. It is reusable and has a life expectancy of over one year.
The mask offers 240 hours of filtering protection and economical replacement filters are available. For example, to protect one thousand persons for a 240 hour duration, the mask disclosed will require 1000 masks in comparison to the N-95 mask, which will require 60,000 respirator masks.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A face mask for use as a procedure mask, isolation mask or dental face mask comprising:
a transparent shell having one opening for covering the nose and mouth of a person;
a housing having a first and a second air passageway and a chamber located therebetween for holding a replaceable filter coupled to the one opening in the transparent shell; and
elastic straps attached to the transparent shell adapted to be placed around a user's head to hold the transparent shell against the face of the user;
wherein the transparent shell is made of a clear latex free plastic.

2. The face mask of claim 1 wherein the housing is of a clear transparent latex free material.

3. The face mask of claim 2 wherein the housing consists of two half sections which can be separated to allow a filter cartridge to be replaced and when joined together forms an air tight seam.

4. The face mask of claim 1 wherein the transparent shell is made of a soft plastic that is both air and water impermeable.

5. The face mask of claim 1 wherein the soft plastic has a Shore A durometer value that is greater than five an less than twenty.

6. The face mask of claim 1 wherein the shell is made of a polyethylene plastic.

7. The face mask of claim 6 wherein the shell is made of a palmer gel.

8. The face mask of claim 7 wherein the shell is formed by injection molding or by thermoforming.

9. The face mask of claim 1 wherein an elbow type of connector is located between the one opening in the shell and the housing to relocate the housing from a vertical position to a horizontal position.

10. The face mask of claim 9 wherein the first and second passageways in the housing are tubes of twenty two and fifteen millimeters respectively and the elbow type of connector has first and second tubes sized to be received by the first and second tubes of the housing respectively.

11. A method of making a face mask for use as a procedure mask, isolation mask or dental face mask comprises:
providing a transparent shell having one opening for covering the nose and mouth of a person;
providing a housing having a first and a second air passageway and a chamber located therebetween for holding a replaceable filter which is coupled to the one opening in the transparent shell; and
attaching elastic straps to the transparent shell which are adapted to be placed around a user's head to hold the transparent shell against the face of the user;
wherein the transparent shell is made of a clear latex free plastic.

12. The method of claim 11 wherein the housing is of a clear transparent latex free material.

13. The method of claim 12 wherein the housing consists of two half sections which can be separated to allow a filter cartridge to be replaced and when joined together forms an air tight seam.

14. The method of claim 11 wherein the transparent shell is made of a soft plastic that is both air and water impermeable.

15. The method of claim 11 wherein the soft plastic has a Shore A durometer value that is greater than five an less than twenty.

16. The method of claim 11 wherein the shell is made of a polyethylene plastic.

17. The method of claim 16 wherein the shell is made of a palmer gel.

18. The method of claim 17 wherein the shell is formed by injection molding or by thermoforming.

19. The method of claim 11 wherein an elbow type of connector is located between the one opening in the shell and the housing to relocate the housing from a vertical position to a horizontal position.

20. The method of claim 19 wherein the first and second passageways in the housing are tubes of twenty two and fifteen millimeters respectively and the elbow type of connector has first and second tubes sized to be received by the first and second tubes of the housing respectively.
